(19) United States
(12) Patent Application Publication
(10) Pub. No.: US 2003/0201945 A1
(43) Pub. Date: Oct. 30, 2003

(54) Antenna for mobile communication device

(76) Inventors: John K. Reece, Colorado Springs, CO (US); John L. Aden, Ocala, FL (US); Charles L. Lindsay, Monument, CO (US); Clinton R. Ransdell, Colorado Springs, CO (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/136,661

(22) Filed: Apr. 30, 2002

(51) Int. Cl. H01Q 9/28; H01Q 1/24

(52) U.S. Cl. 343/795; 343/702

(57) ABSTRACT

A mobile antenna system may be integrated with or attached to a mobile communication device. The system may include a mobile antenna assembly and a sleeve protector. The sleeve protector and antenna assembly may be attached to an external surface of a mobile communication device or integrated into the housing of such a device. The antenna assembly may be deployed from the sleeve protector in various manners, with permanent or detachable RF connections between the antenna and the mobile device.

Conventional wireless data modems configured to operate with laptop Personal Computers (“PCs”) are typically designed with fixed, embedded, “stubby” flip-up antennas that are part of a Personal Computer Memory Card International Association (PCMCIA) card product. Additionally, conventional wireless data modems are being designed with full quarter-wave and half-wave flip-up antennas as part of the PCMCIA card product.

The desirable performance levels for efficiency (gain) and radiation pattern of these conventional antennas are necessarily compromised pursuant to cost and/or aesthetic requirements. Furthermore, the overall performance of these conventional antennas may be reduced due to the proximity effect of the PC keyboard, screen, processor, and card driver circuitry.

While such conventional antennas may provide adequate performance in areas of high base station deployment density characterized by high carrier power levels, they may be inadequate in areas where the base station density and carrier power levels are low. Therefore, what is needed is; a mobile antenna system that overcomes these problems found in the conventional antenna systems.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a view of the mobile antenna system integrated into the mobile communication device according to an embodiment of the present invention;

FIG. 2 is a view of a mobile antenna system attached external to a mobile communication device according to another embodiment of the present invention;

FIG. 3 is a view of a pullout mobile antenna system of FIGS. 1-2;

FIG. 4 is a view of a rotate-out mobile antenna system of FIGS. 1-2;

FIG. 5 is a view of an antenna assembly usable with the mobile antenna systems of FIGS. 3-4;

FIG. 6 is a view showing one side of the antenna assembly of FIG. 5;

FIG. 7 is a view showing another side of the antenna assembly of FIG. 5;

FIG. 8 is a view of another alternative embodiment of an antenna assembly usable with the mobile antenna systems of FIGS. 3-4, particularly showing one side of the antenna assembly; and

FIG. 9 is a view of the antenna assembly of FIG. 8, particularly showing another side of the antenna assembly.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention.

However, it will be understood by those skilled in the art that the present invention may be practiced without these specific details. In other instances, well-known methods, procedures, components and circuits have not been described in detail so as not to obscure the present invention.

Embodiments of the present invention may be used in a variety of applications. Although the present invention is not limited in this respect, the circuits disclosed herein may be used with microcontrollers, general-purpose microprocessors, Digital Signal Processors (DSPs), Reduced Instruction-Set Computing (RISC), Complex Instruction-Set Computing (CISC), among other electronic components. However, it should be understood that the scope of the present invention is not limited to these examples.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

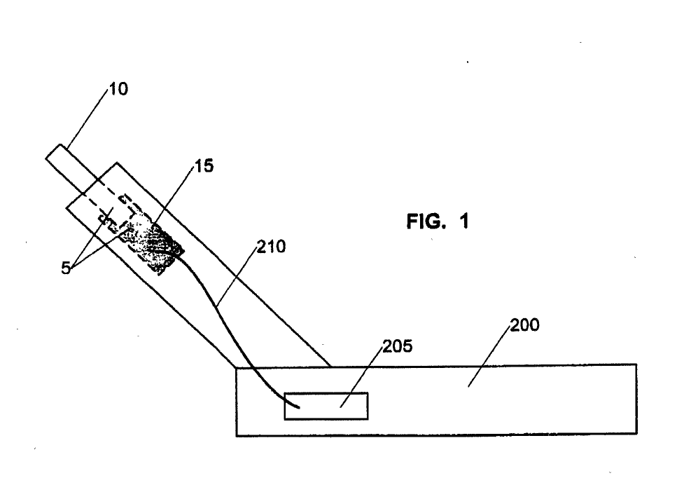

FIG. 1 shows a mobile communication device 200 with a mobile antenna assembly 5 integrated according to an embodiment of the present invention. Mobile communication device 200 is shown as a laptop computer, but it should be understood that other mobile computing devices such as, for example, cellular radiotelephone communication systems, two-way radio communication systems, one-way pagers, two-way pagers, Personal Communication Systems (PCS), Personal Digital Assistants (FPDA's), cameras and other products are intended to be included within the scope of the present invention.

A sleeve protector may be integrated into the housing or attached to an external surface of a mobile communication device or such a device. Sleeve protector 15 serves to house and protect antenna 10 when not deployed such as, for example, during transportation of the mobile communication device 200. In an embodiment where mobile communication device 200 is a laptop computer, sleeve protector 15 may be integrated into the plastic housing of the laptop computer, one location being near the computer screen.

Antenna 10 may be deployed from the sleeve protector in various manners. For example, antenna 10 may be deployed by pulling the antenna out of the sleeve and into its operable position. Alternatively, antenna 10 may be deployed by rotating the antenna out of the sleeve protector 15 and into its operable position. In each of the various manners of deploying antenna 10, the antenna assembly is communicatively coupled with the mobile communication device when the antenna is in the operable position. When the antenna is deployed, the top of the antenna may extend beyond the mobile communication device in order to provide improved wireless data modem performance. The deployed antenna system may be positioned so that its RF performance is not affected by its proximity to the mobile communication device. When the antenna is not in use it may be retracted to a position for storage and transportation.

The mobile antenna assembly 5 is communicatively coupled to mobile communication device 200 through a communications link 210 and an interface 205. Antenna 10 provides the function of sending and receiving wireless communications when deployed and operates with an omni-directional azimuthal radiation pattern shape. Communications link 210 between mobile antenna assembly 5 and mobile communication device 200 may be a wired connection such as, for example, a coaxial cable connector. If mobile antenna assembly 5 is integrated into the housing of mobile communication device 200, communications link 210 may also be integrated into the housing of mobile communication device 200. Alternatively, if a removable connection to interface 205 is preferred, sleeve protector 15 may include a connector (not shown) for establishing a communication link 210 with interface 205. In either case, interface 205 may be a Personal Computer Memory Card International Association (PCMCIA) card inserted into a PCMCIA type 11 or type III slot on mobile communication device 200.

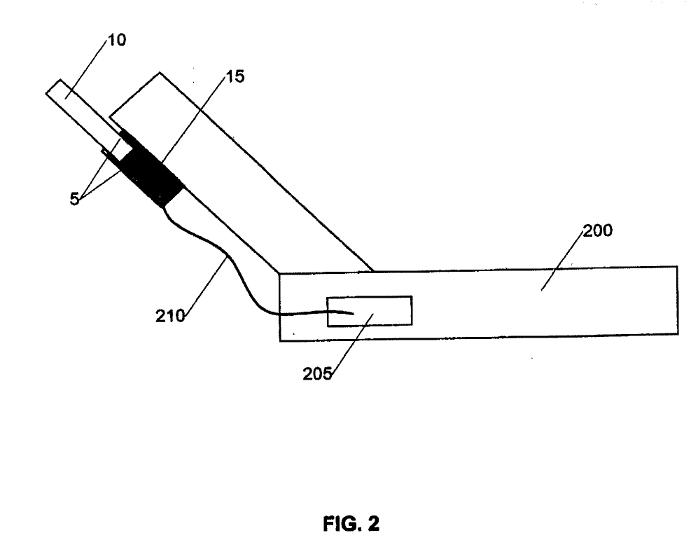

FIG. 2 shows mobile antenna assembly 5 removably attached to mobile communication device 200 according to an embodiment of the present invention. In this embodiment, sleeve protector 15 is not integrated into mobile communication device 200. If sleeve protector 15 is to be removably attached to the mobile communication device 200, the attachment may be made using a Velcro™, bracket or snap-fit arrangement.

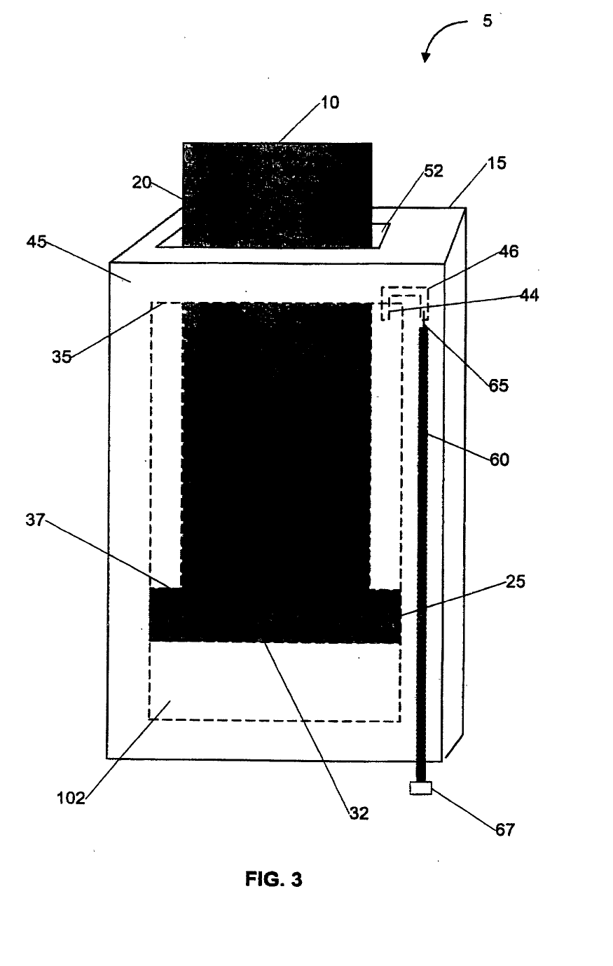

FIG. 3 illustrates a mobile antenna system having a pullout configuration. The mobile antenna system comprises an antenna 10 that includes a printed circuit board or substrate 32 on which an antenna element 20 and an antenna feed line 25 are supported. Substrate 32 may be manufactured from a number of compositions including a standard fiber epoxy board and have a conductive laminate layer. Typically, the electrically conductive layer may be, for example, copper, gold or platinum disposed over at least one side of substrate 32. From this electrically conductive layer, antenna element 20 and feed line 25 are etched. The feed line 25 preferably has an impedance of 50 ohms. Antenna element 20 may be a simple di-pole antenna element 20.

Antenna 10 is a planar antenna assembly that when formed on a printed circuit board or substrate may have a rectangular shape, although this is not a limitation of the present invention. Thus, unlike many prior art antenna for mobile communication devices having a cylindrical shape, the planar shape of antenna 10 may provide a form factor that is easily integrated into portable devices.

Sleeve protector 15 may include a sleeve wall 45 that defines a cavity 102 in which antenna assembly 5 may move. One end of the sleeve wall 45 has an opening 52 through which antenna assembly 5 may alternately be deployed and retracted. Sleeve protector 15 may further include a pair of opposing shoulders 35 that extend along the inner surface of the sleeve wall 45 adjacent to the opening 52. Shoulders 37 of substrate 32 prevent antenna assembly 5 from sliding entirely out of cavity 102.

Sleeve protector 15 may further include a spring connector 44 with an associated electrical conductor 46. Spring connector 44 may include a pair of electrically conductive tabs extending into the cavity 102. The tabs may engage opposing surfaces of feed line 25 to provide electrical communication between antenna element 20 and electrical conductor 46. Electrical conductor 46 is communicatively coupled with coaxial electrical conductor 65 of coaxial cable 60. Coaxial cable 60 may be coupled through coaxial connector 67 to communication link 210 (shown in FIG. 1). Coaxial connector 67 may be integrated into sleeve protector 15 or extend beyond the protective sleeve.

From a recessed position, antenna 10 may be deployed by moving the antenna assembly to a position where a portion of the antenna extends from sleeve protector 15 through an opening 52. Deployment may include a manual or software controlled release. When the antenna 10 is deployed, the antenna feed line 25 and antenna element 20 remain communicatively coupled with the coaxial cable connector 60 via antenna spring connector 44, such that mobile antenna assembly 5 is operable.

FIG. 4 illustrates a mobile antenna assembly 5 having a rotate-out configuration. Antenna 10 may include a substrate 32 on which antenna element 20 and antenna feed line 25 are supported. Antenna assembly 5 may include a sleeve protector 15 having a spring connector 44 and an associated electrical conductor 46. In this embodiment, antenna 10 may rotate into an operating position. Tabs may engage opposing surfaces of feed line 25 to provide electrical communication between antenna element 20 and electrical conductor 46. Electrical conductor 46 remains communicatively coupled with coaxial electrical conductor 65 that is integrated with coaxial cable 60. Coaxial cable 60 may be coupled with communication link 210 (FIG. 1) through coaxial connector 67. Coaxial connector 67 may be integrated into sleeve protector 15 or extend beyond the protective sleeve.

Sleeve protector 15 may further include a pivot pin 109, which transversely extends through sleeve cavity 102 and substrate 32 via a pin aperture 115. In this manner, rotation of antenna 10 about the axis created by pivot pin 109 alternately deploys and retracts antenna 10 with respect to sleeve protector 15. Pivot pin 109 may be positioned toward one end of sleeve protector 15, such that when antenna 10 rotates about pivot pin 109, a portion of antenna 10 rotates through an opening 52 in sleeve protector 15.

Alternatively, pivot pin 109 may be a rotating RF connector that is communicatively coupled with electrical conductor 46. RF signals from antenna feed line 25 may pass through the rotating RF connector pivot pin 109 through coaxial electrical conductor 65 associated with coaxial cable 60 to coaxial connector 67 and finally to communications link 210 (FIG. 1). A separate spring connector is not required for mating to feed line 25 in this embodiment. Antenna 10 may be retracted through various means including a manual or software controlled initiation. For example, retraction may be initiated by depressing antenna 10 into sleeve protector 15, or alternatively, retraction may be initiated by software control that causes antenna 10 to rotate.

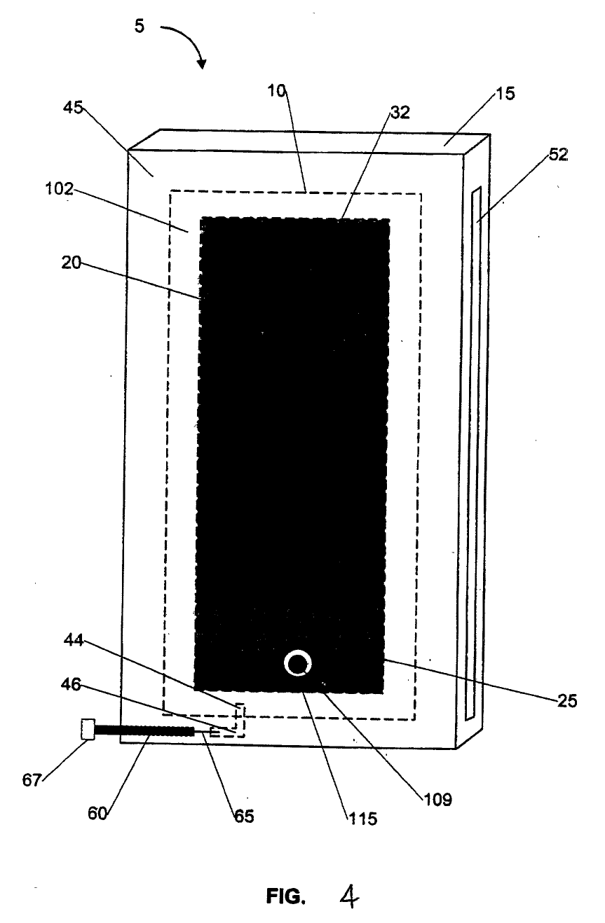

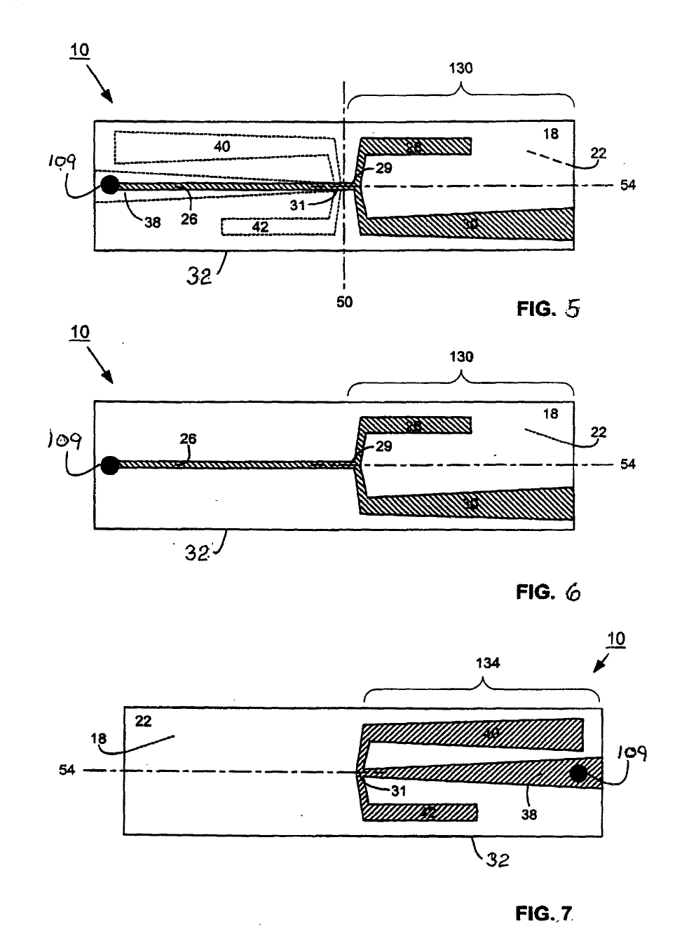

FIG. 5 illustrates a planar antenna assembly or dipole that may be used for antenna 10. Antenna sets 130 and 134 may be disposed on first and second surfaces 18 and 22 of a substrate 32. Solid lines are intended to indicate that antenna set 130 is on surface 18, while dashed lines indicate that the antenna set 134 is on surface 22. Conductive pivot pin 109 may be a rotating RF connector that is communicatively coupled with an electrical conductor (not shown). A microstrip transmission line 26 may be etched on surface 18. Microstrip transmission line 26 preferably has an impedance of about 50 ohms. RF pivot pin 109 is located at one end of microstrip transmission line 26 and dipole antenna elements 28 and 30 are located at the other end. Thus, microstrip transmission line 26 starts at a feedpoint of pivot pin 109 and terminates at an antenna feedpoint 29.

FIG. 6 illustrates the first set 130 of broadband dipole antenna elements 28 and 30 that are physically and electrically coupled to microstrip transmission line 26 through antenna feedpoint 29 on surface 18. Antenna element 28 may extend from antenna feedpoint 29 and a position slightly right of the vertical axis 50 (which is a frame of reference), to a rectangular dipole antenna element 28. Dipole antenna element 28 may have dimensions of approximately 1.055 inches (2.68 cm) in width and 0.20 inches (0.51 cm) in height, which provides dipole antenna element 28 al resonant frequency range of approximately 1700-2500 MHz.

Antenna element 30 may extend from antenna feedpoint 29 and a position slightly right of vertical axis 50 into a trapezoid shaped dipole antenna element 30. Antenna element 30 may be tapered to increase its bandwidth in the frequency bands of interest. The dimensions of dipole antenna element 30 may be about 0.20 inches (0.51 cm) in height at one end and about 0.36 inches (0.91 cm) in height at the other end, and having a length of about 2.10 inches (5.33 cm). The tapered dipole antenna element 30 may have a resonant frequency range of approximately 800 MHz to 960 MHz. The physical dimensions of dipole antenna elements 28 and 30 are not intended to limit the scope of the claimed invention.

FIG. 7 (note reversal from FIG. 5) illustrates the second set 134 of broadband dipole antenna elements 40 and 42 that are physically and electrically coupled to a feedline balun/transformer 38 on second surface 22. Antenna element 40 may be tapered, from a narrow portion nearer second feedpoint 31 and broader as it extends in the direction of pivot pin 109. Antenna element 42 may have a rectangular shape, similar to the shape of antenna element 28. Transformer 38 may be tapered, having a narrow dimension near the launch feedpoint at pivot pin 109 and increasing in width towards second dipole feedpoint 31. Transformer 38 may have dimensions of about 0.40 inches (1.02 cm) on one end and about 0.05 inches (0.13 cm) on the other end, having a length of about 2.88 inches (7.32 cm).

The two dipole antenna elements on surface 18 and on surface 22 of substrate 32 may be inverted mirror images of each other, meaning that antenna element 42 may be similar in shape to antenna element 28 but reflected about a horizontal axis 54 and a vertical axis 50. Likewise, antenna element 40 may be a replica of antenna element 30, but reflected about the vertical axis 50 and the horizontal axis 54. Pivot pin 109 may be a spectrum multiple access (SMA) connector end launch and electrically couple the conductive elements on surface 18 and the conductive elements on surface 22 to a coaxial cable. According to one embodiment, the outer shield of the coaxial cable may be connected to balun/transformer 38 and the inner conductor of the coaxial cable may be connected to microstrip transmission line 26. With the coaxial cable connected to balun/transformer 38 and pivot pin 109, an unbalanced 50-ohm microstrip transmission line 26 may be transformed into a 70-ohm dual strip feedline at antenna feedpoint 29.

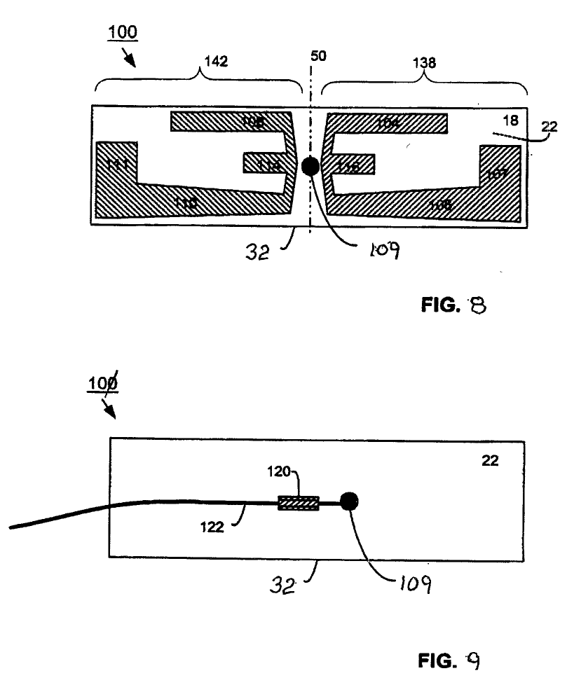

FIG. 8 depicts another embodiment of an antenna 100, characterized by two sets 138 and 142 of dipole antenna elements that are both on the same side of substrate 32. Each set of dipole antenna elements may be thought of having four components. Elements 104 and 108 are broadband antenna elements having a rectangular shape. Elements 106 and 110 are tapered lower frequency elements. The two sets 138 and 142 of dipole antenna elements may further include pads 114 and 116 that may be centered between the two major elements of each set of dipole antenna elements. Extension tuning elements 107 and 111 may be added to the respective ends of elements 106 and 110.

FIG. 9 illustrates surface 22 of antenna 100. A connector 120 may help secure a coaxial cable 122 to substrate 32. The center conductor of coaxial cable 122 may be connected to one of the dipole antenna elements such as pivot pin 109 that passes through substrate 32 to connect with pad 116 (FIG. 8). The shield of coaxial cable 122 may be connected to connector 120 on the backside of substrate 32 and electrically coupled to an antenna element through a series of vias in the substrate.

By now it should be clear that embodiments have been presented for a mobile communication device having an antenna system that may be integrated into the device. The antenna system may be deployed during periods where the mobile communication device is transmitting and receiving signals, but otherwise retracted when the mobile communication device is not active.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A mobile system, comprising:
a sleeve defining an interior cavity in a mobile communication device; and
a planar antenna assembly to be deployed from the interior cavity and retracted into the interior cavity.

2. The mobile system of claim 1, wherein the planar antenna assembly includes:
a first set of dipole antenna elements tuned to receive a plurality of frequency bands and a second set of dipole antenna elements tuned to receive another plurality of frequency bands.

3. The mobile system of claim 2, wherein the second set of dipole antenna elements is substantially a reflected version of the first set of dipole antenna elements.

4. The mobile system of claim 1, wherein the sleeve is removably attached to the mobile communication device.

5. The mobile system of claim 1, wherein the mobile communication device is a mobile computing device.

6. The mobile system of claim 1, wherein the sleeve comprises:
a shoulder in the interior cavity that engages a shoulder in the planar antenna assembly when the planar antenna assembly is deployed.

7. The mobile system of claim 1, wherein the planar antenna assembly is deployed by rotating out from the protective sleeve.

8. The mobile system of claim 1, further comprising a pivot pin that extends through the planar antenna assembly, wherein the planar antenna assembly pivots about the pivot pin to retract and deploy.

9. A mobile system, comprising:
a protective sleeve defining an interior cavity and integrated within a mobile communication device; and
a planar antenna assembly having first and second antenna elements formed on a substrate to be retracted into the interior cavity and deployed from the interior cavity.

10. The mobile system of claim 9, wherein the first antenna element is tuned to a first frequency band and the second antenna element is tuned to a second frequency band.

11. The mobile system of claim 10, wherein the second antenna element is substantially a reflected version of the first antenna element.

12. The mobile system of claim 9, further comprising a pivot pin that extends through the planar antenna assembly, wherein the planar antenna assembly pivots about the pivot pin to retract and deploy.

13. The mobile system of claim 12, wherein the first and second antenna elements formed on the substrate are deployed by rotating out from the protective sleeve.

14. The mobile system of claim 9, wherein the first and second antenna elements formed on the substrate are deployed by linearly extending out of the protective sleeve.

15. A system, comprising:
a mobile communication device having an interior cavity; and
a planar antenna assembly having first and second antenna elements formed on a substrate to retract into the interior cavity and deploy from the interior cavity, wherein the first antenna element tunes to a first frequency band and the second antenna element tunes to a second frequency band.

16. The system of claim 15, wherein the mobile communication device is a computer.

17. The system of claim 16, wherein interior cavity in the mobile communication device is other than a Personal Computer Memory Card International Association (PCMCIA) slot in the computer.

18. The system of claim 15, wherein the first antenna element is formed on a first side of the substrate and the second antenna element is formed on a second side of the substrate.

19. The system of claim 15, wherein the first and second antenna elements are formed on the same side of the substrate.

20. The system of claim 15, wherein the first antenna element is a rectangular element and the second antenna element is a trapezoidal element.

21. A method, comprising:
deploying a planar antenna from a mobile communication device;
receiving in the planar antenna a first frequency band on a first antenna element formed on a substrate; and
receiving in the planar antenna a second frequency band on a second antenna element formed on the substrate.

22. The method of claim 21, wherein deploying the planar antenna further includes controlling the deployment using software.

23. The method of claim 21, wherein deploying the planar antenna further includes providing the deployment manually.
